(19) United States
(12) Patent Application Publication
(10) Pub. No.: US 2013/0286929 A1
(43) Pub. Date: Oct. 31, 2013

(54) RELAY STATION DEVICE, BASE STATION DEVICE, COMMUNICATION SYSTEM AND COMMUNICATION METHOD

(71) Applicant: Hidekazu Tsuboi, Osaka-shi (JP)

(72) Inventor: Hidekazu Tsuboi, Osaka-shi (JP)

(73) Assignee: SHARP KABUSHIKI KAISHA, Osaka-shi, Osaka (JP)

(21) Appl. No.: 13/876,891

(22) PCT Filed: Sep. 27, 2011
(86) PCT No.: PCT/JP2011/072066

§ 371 Date: Jun. 5, 2013

(30) Foreign Application Priority Data
Oct. 1, 2010 (JP) 2010-223609

(51) Int. Cl. H04B 7/15

(52) U.S. Cl. CPC H04B 7/15
USPC 370/315

(57) ABSTRACT

In a communication system including a base station device and a relay station device, the base station device notifies the relay station device of the identifier of an MBSFN area and whether the subframe used by the service of the identifier of the MBSFN area should be set up in the MBSFN subframes, and, the relay station device, based on the identifier of the MBSFN area held thereby and the information on the subframe used by the service of the identifier of the MBSFN area, controls whether the subframe used by the service of the identifier of the MBSFN area, notified from the base station device, should be included in the MBSFN subframes thereof, based on a notice as to whether the subframe used by the service of the identifier of the MBSFN area is set up in the MBSFN subframes.

### TECHNICAL FIELD

The present invention relates to a relay station device, base station device, communication system and communication method.

### BACKGROUND ART

Evolution of wireless access systems and wireless networks of cellular mobile communication (which will be referred to hereinbelow as “Long Term Evolution (LTE)” or “Evolved Universal Terrestrial Radio Access (EUTRA)” has been investigated by 3GPP, the third Generation Partnership Project. In LTE, orthogonal frequency division multiplexing (Orthogonal Frequency Division Multiplexing: OFDM), which is multicarrier transmission, is used as the communication scheme of the (downlink) radio communication from the base station device to mobile station device. On the other hand, SC-FDMA (Single-Carrier Frequency Division Multiple Access) which is single carrier transmission, is used as the communication scheme of (uplink) radio communication from a mobile station device to the base station device.

FIG. 6 is a diagram showing one example of radio frame configuration in LTE. In FIG. 6, the direction of the horizontal axis shows the time axis, and the direction of the vertical axis shows the frequency axis. One unit radio frame is composed of 12 subcarriers (sc) in the direction of the frequency axis and a plurality of slots, each a group of OFDM symbols, in the direction of the time axis. A unit region that is assigned with 12 subcarriers and sectioned by one slot length is called a resource block. A subframe is formed of two slots, and one radio frame is formed of 10 subframes. A plurality of resource blocks are continuously arranged in the frequency direction.

In FIG. 6, subframes #0 and #5 include the primary synchronization channel (Primary Synchronization Channel; P-SCH) which is used by mobile station device and relay station device to synchronize with the cell under control of the base station device, the secondary synchronization channel (Secondary Synchronization Channel; S-SCH) and the primary broadcast channel (Primary Broadcast Channel; P-BCH).

The mobile station device synchronizes the cell by use of the synchronization channels to acquire the physical cell ID. Then, the mobile station device demodulates P-BCH to obtain principal parameters such as the number of transmitting antenna ports etc., and obtain the other broadcast information from the dynamic broadcast channel (Dynamic Broadcast Channel; D-BCH) arranged in the downlink shared channel (Downlink Shared Channel; DL-SCH). The information included in D-BCH is divided into a plurality of blocks depending on the type of information, each block being a unit called SIB (System Information Block) and each block is broadcast in a cycle of an individual period.

The downlink control channel (Physical Downlink Control Channel (PDCCH) is arranged in the leading OFDM symbol of one subframe, and the number of OFDM symbols from 1 to 4 to be distributed with PDDCCH is designated through the control format indicator channel (Physical Control Format Indicator Channel: PCFICH).

Further, a reference signal (Downlink Reference Signal; DL-RS) necessary for demodulation and measurement of reception quality is included within a subframe. The allocation of the reference signal in the subcarriers is uniquely designated by the aforementioned physical cell ID. The mobile station device, based on the reference signal, performs measurement of reception quality and compensation of the propagation path for PDCCH, and if the mobile station detects allocation of data addressed to its own mobile station from PDCCH, the mobile station demodulates ODFM symbols after the PDCCH to obtain the data addressed to the own station.

In LTE, implementation of multimedia broadcast communication service (Multimedia Broadcast/Multicast Service; MBMS) has been investigated. MBMS is expected to offer broadcast service of identical information in a wide area covering multiple cells. In order to reduce the occurrence of interruption during the service due to switching of frequency when the mobile station device moves from one cell to another in the process of MBMS transmission, there is a contrivance called MBSFN (Multimedia Broadcast Single Frequency Network) which transmits the same MBMS in multiple cells using a carrier wave of single frequency network (Single Frequency Network; SFN) in the area.

Since, in LTE, the position of the reference signal in the subframe for MBSFN transmission differs from that of the other subframes, there occurs malfunction in the process at the mobile station device. Accordingly, the subframes for MBSFN transmission are adapted to be notified by information block called SIB2.

Further, in LTE, a physical multicast channel (Physical Multicast Channel; PMCH) for MBSFN transmission is provided, the information block on the subframes to which PMCH is allotted is informed by SIB13 as one of SIBs (non-patent document 1). Since in LTE it is possible to configure a plurality of MBSFN areas in a single cell, SIB13 notifies the identifier for identifying an MBSFN area and information on the subframe the service of the identifier uses.

Herein, the subframes designated by SIB13 are not all of the subframes notified by SIB2. The subframes not designated by SIB13 can be used for other than MBMS transmission. For example, nonuse of transmission may reduce power consumption, or when used for an aftermentioned relay station device, the subframes can be used for communication between the relay station device and the base station device.

In the case of an MBSFN subframe, the reference signal in the first 20 FDM symbols from the lead has the same structure as that in a normal subframe. PDCCH is also allotted. The remaining OFDM symbols are used for MBMS.

In this way, in the subframe for MBSFN in LTE, it has been investigated that compensation of the propagation path of PDCCH and measurement of reception quality should be implemented by use of only the reference signal included in the first 20 FDM symbols from the lead.

Further, in order to enlarge communication permissible range (coverage) of mobile station devices and increase in channel capacity (capacity), use of relay station devices has been investigated in LTE. A relay station device performs communication with a core network by a wireless link (backhaul link) with a base station device (DeNB) of a normal cell and also performs communication with a mobile station device by a wireless link (access link) with the mobile station device. That is, the relay station device relays communication between the mobile station device and the base station device by use of the aforementioned two wireless links. It is prescribed in LTE that MBSFN subframes can be used for backhaul link communication.

FIG. 7 is a schematic diagram of a communication system including a relay station device. In FIG. 7, a mobile station device Ua communicates with a base station device Na. Base station device Na perform MBMS services and offers the services to mobile station device Ua by use of MBSFN subframes (subframes #2 and #6 herein) as shown in FIG. 8. Further, base station device Na is the DeNB of a relay station device Ra. Relay station device Ra configures MBSFN subframes in part (subframes #1 and #3 herein) of the subframes other than those the aforementioned base station device Na performs MBMS services to use the MBSFN subframes for backhaul link communication. A mobile station device Ub connects to relay station device Ra to perform communication.

Now, suppose that mobile station device Ua is located near the cell of relay station device Ra, mobile station device Ua receives the signal transmitted from relay station device Ra to mobile station device Ub as an interference signal when receiving the MBMS service from base station device Na, hence the reception quality of the MBMS at mobile station device Ua degrades. If relay station device Ra is a normal base station device, it is possible to limit the usage of MBSFN subframes for offering MBMS services by means of MCE (Multi-cell/multicast Coordination Entity) controlling the base station devices inside MBSFN area. However, since a relay station device cannot connect to MCE in the existing LTE, it is proposed that relay station device Ra itself additionally configures similar MBSFN subframes, based on information of SIB2 and SIB13 of DeNB (base station device Na) so that the aforementioned MBSFN subframes will not be used for transmission of PMCH, to prevent occurrence of interference (non-patent document 2).

### PRIOR ART DOCUMENTS

### Non-Patent Documents

Non-patent document 1: 3GPP TS36.331, Radio Resource Control (RRC); Protocol specification. V9. 3.0(http://www.3gpp.org/ftp/Specs/html-info/36331.htm)
Non-patent document 2: CMCC, CATR, ZTE, 2 Considerations on deployment of both relay and MBMS”, R2-104553, 3GPP TSG-RAN WG2 meeting #71, Madrid, Spain, 23-27 Aug. 2010

### SUMMARY OF INVENTION

### Problems to be Solved by the Invention

When radio transmission of the relay station device by the subframe is simply stopped in order to prevent the occurrence of interference on the MBMS of DeNB, radio usage efficiency is lowered. On the other hand, if radio transmission is simply performed using the subframe, interference occurs.

In view of the above problems of the present invention, it is an object of the present invention to provide a relay station device, a base station device, a communication system and a communication method, which can alleviate the lowering of radio usage efficiency by introducing a contrivance of determining the necessity of suspension of radio transmission.

### Means for Solving the Problems

(1) In order to attain the above object, the present invention provides the means as follows. That is, a relay station device in a communication system of the present invention is a relay station device including an MBSFN information collector that acquires and holds the identifiers of MBSFN areas of peripheral cells thereof and the used subframes, wherein when there is only one peripheral cell, the relay station device, among the MBSFN subframes of the peripheral cell, the subframe to which the identifier of an MBSFN area is allotted is set to be included in the MBSFN subframes thereof.

(2) A relay station device in a communication system of the present invention is a relay station device including an MBSFN information collector that acquires and holds the identifiers of MBSFN areas of peripheral cells thereof and the used subframes, wherein when there are a plurality of peripheral cells, the relay station device, among the MBSFN subframes of the peripheral cells, the same subframes to which the identifier of the same MBSFN area is allotted is set to be included in the MBSFN subframes thereof.

(3) Abase station device in a communication system of the present invention is a base station device that communicates with a relay station device, characterized in that the base station device notifies the relay station device of the identifier of an MBSFN area and whether the subframe used by the service of the identifier of the MBSFN area should be included in the MBSFN subframes of the relay station device.

(4) A relay station device in a communication system of the present invention is a relay station device that communicates with the base station device, characterized in that the relay station device holds the identifier of the MBSFN area of the base station device and information on the subframe used by the service of the identifier of the MBSFN area, and the relay station device controls whether the subframe used by the service of the identifier of the MBSFN area, notified from the base station device, should be included in the MBSFN subframes thereof, based on a notice as to whether the subframe used by the service of the identifier of the MBSFN area is set up in the MBSFN subframes.

(5) A communication system of the present invention is a communication system including a base station device and a relay station device, wherein the relay station device holds information on reception power from peripheral cells thereof, the identifier of the MBSFN area of the peripheral cell to which the relay station connects and the subframe used by the service of the identifier of the MBSFN area, and the relay station device notifies the reception power of the peripheral cells to the base station device that controls the peripheral cell to which the relay station connects, the base station device notifies the relay station device of the identifier of an MBSFN area and whether the subframe used by the service of the identifier of the MBSFN area should be set up in the MBSFN subframes, and, the relay station device, based on the identifier of the MBSFN area held thereby and the information on the subframe used by the service of the identifier of the MBSFN area, controls whether the subframe used by the service of the identifier of the MBSFN area, notified from the base station device, should be included in the MBSFN subframes thereof, based on a notice as to whether the subframe used by the service of the identifier of the MBSFN area are set up in the MBSFN subframes.

(6) A communication system of the present invention wherein a base station device and a relay station device are provided, includes: a step in which the relay station device holds information on reception power from peripheral cells thereof, the identifier of the MBSFN area of the peripheral cell to which the relay station connects and the subframe used by the service of the identifier of the MBSFN area, a step in which the relay station device notifies the reception power of the peripheral cells to the base station device that controls the peripheral cell to which the relay station connects, a step in which the base station device notifies the relay station device of the identifier of an MBSFN area and whether the subframe used by the service of the identifier of the MBSFN area should be set up in the MBSFN subframes, and, a step in which the relay station device, based on the identifier of the MBSFN area held thereby and the information on the subframe used by the service of the identifier of the MBSFN area, controls whether the subframe used by the service of the identifier of the MBSFN area, notified from the base station device, should be included in the MBSFN subframe thereof, based on a notice as to whether the subframes used by the service of the identifier of the MBSFN area is set up in the MBSFN subframes.

### Effect of the Invention

According to the present invention, it is possible to provide a wireless communication system, a relay station device and a communication method, which can mitigate interference on MBMS while alleviating the lowering of radio usage efficiency.

### BRIEF DESCRIPTION OF DRAWINGS

FIG. 1 is a block diagram showing one example of a base station device according to the embodiment of the present invention.

FIG. 2 is a block diagram showing one example of a relay station device according to the embodiment of the present invention.

FIG. 3 is a block diagram showing one example of a mobile station device according to the embodiment of the present invention.

FIG. 4 is a sequence chart showing the procedures of configuring MBSFN subframes in the first embodiment of the present invention.

FIG. 5 is a sequence chart showing the procedures of configuring MBSFN subframes in the second embodiment of the present invention.

FIG. 6 is a diagram showing one example of a frame structure in a communication system according to the present invention.

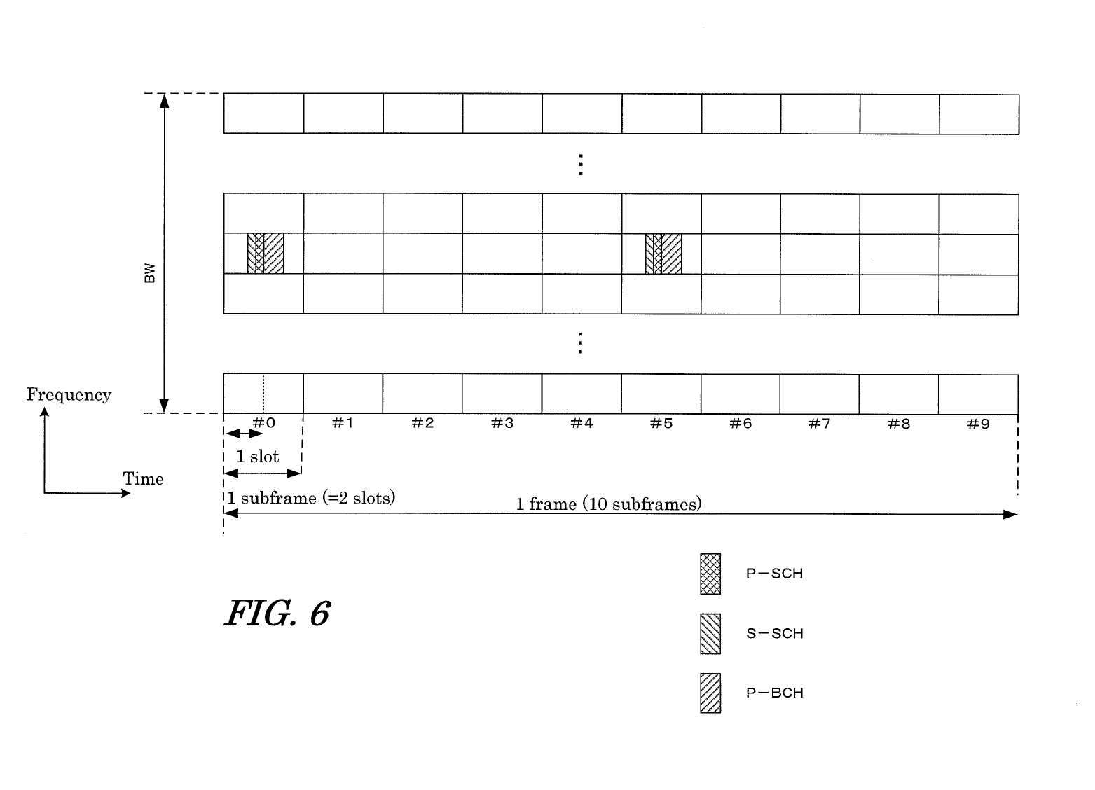

FIG. 7 is a diagram showing one example of a communication system configuration according to the present invention.

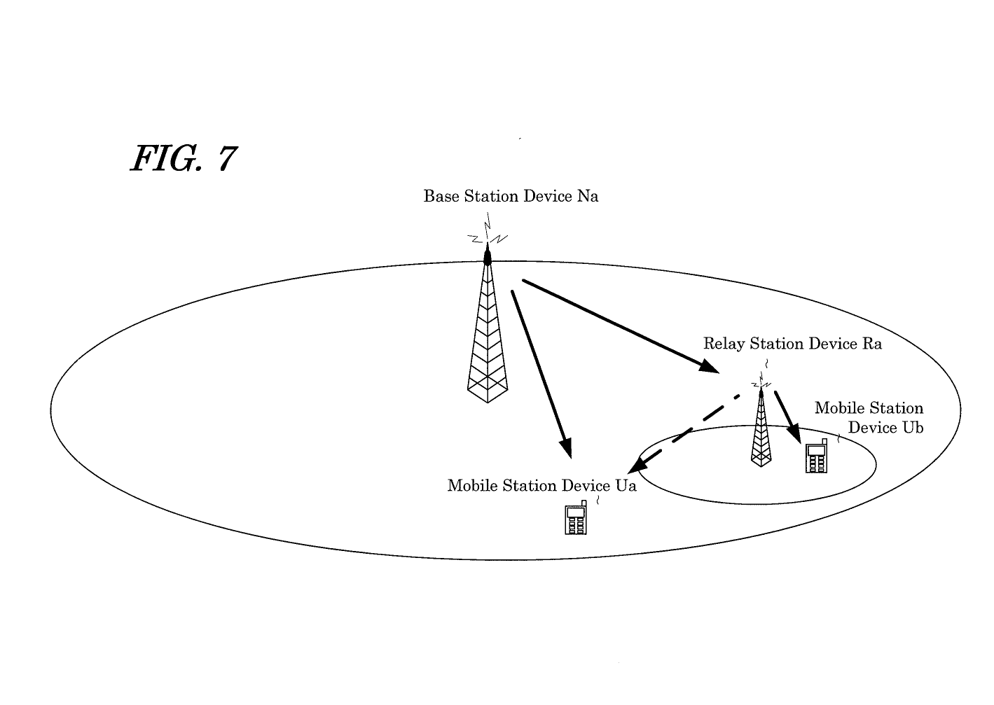

FIG. 8 is a diagram showing interference of a relay station device on the conventional MBMS service.

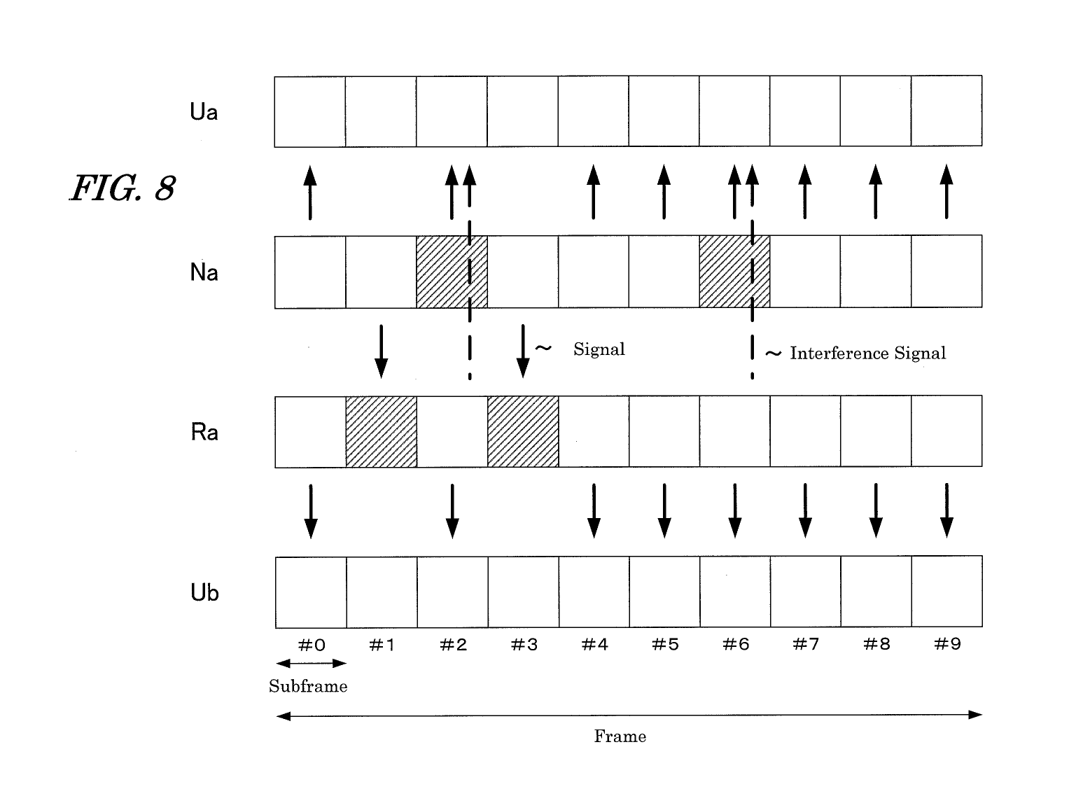

### BEST MODE FOR CARRYING OUT THE INVENTION

Before describing the embodiment of the present invention, physical channels relating to the present invention will be described.

[Physical Channel]

Physical channels (or physical signals) used in LTE will be described. As the physical channels there exist a downlink channel on the downlink for transmission from a base station device to a mobile station device and an uplink channel on the uplink for transmission from a mobile station device to a base station device. In LTE, a new physical channel may be added or the structure of the physical channels may be modified in the future, but if any modification is made, description of each embodiment of the present invention will not be affected.

Synchronization signals (Synchronization Signals) are made up of three kinds of primary synchronization signals and secondary synchronization signals in which 31 kinds of codes are arranged alternately across the frequency band. By signal combinations of the primary synchronization signals and the secondary synchronization signals presents, 504 cell identifiers (physical ID, PCI; Physical Cell Identifier) for identifying a base station device and the frame timing for wireless synchronization are given. The mobile station device and the relay station device identify the transmission timing (frame timing), physical cell ID of the cell, from the synchronization signal that is received by a cell search.

A physical broadcast channel (PBCH; Physical Broadcast Channel) is transmitted aiming at notifying control parameters (broadcast information (system information); System information) to be shared by mobile station devices inside the cell. As to the broadcast information that is not notified by the physical broadcast channel, the radio resource is notified by the downlink control channel so that the information is transmitted by a layer 3 message (system information) through the downlink data channel. Notified as the broadcast information are a cell global identifier (CGI; Cell Global Identifier) showing the identifier of an individual cell, the class of terminals that can access, a tracking area identifier (TAI; Tracking Area Identifier) for managing the standby area by paging, the frequency bandwidth of the cell and the correspondence between downlink and uplink frequency bands, MBSFN subframes and information on allocation of MBSFN subframes used for MBMS services, and others. The mobile station device in its idling state or the relay station device acquires the above broadcast information from the cells detected by a cell search and selects the best cell for its own station to perform communication.

A downlink reference signal is a pilot signal that is transmitted from each cell at a predetermined power. The downlink reference signal is a known signal periodically repeated at frequency and time positions based on a predetermined rule, and the position and sequence of the signal are uniquely determined by the physical cell ID. As receiving the downlink reference signal, the mobile station device measures reception quality (reception power, signal to interference plus noise ratio, etc.) of each cell. The mobile station device also uses the downlink reference signal as a signal for reference to demodulate the downlink control channel or downlink data channel that is transmitted simultaneously with the downlink reference signal. The sequence to be used for the downlink reference signal is one that can be identified for each cell. It is noted that the downlink reference signal may be also named as cell-specific RS (Cell-specific reference signals), but its utility and meaning are the same.

A downlink control channel (PDCCH; Physical Downlink Control Channel) is transmitted by use of several OFDM symbols from the lead of each subframe and is used aiming at giving information on allocation of radio resources according to the scheduling of the base station device and indicating adjustment for variation in transmission power, to the mobile station device. The mobile station device needs to monitor the downlink control channel addressed thereto before transmitting and receiving downlink data and layer 3 messages (paging, handover command, etc.) as downlink control data, and receive the downlink control channel addressed thereto, to thereby acquire information on allocation of radio resources, called an uplink grant upon transmission and a downlink grant upon reception.

A downlink data channel (PDSCH; Physical Downlink Shared Channel) is not only used for downlink data, but also used for notifying paging and broadcast information as layer 3 messages or downlink control data. Information on allocation of radio resources on the downlink data channel is given by the downlink control channel.

There also are a downlink control channel and a downlink data channel, dedicatedly addressed to relay station devices, which are called R-PDCCH and R-PDSCH, respectively.

An uplink data channel (PUSCH; Physical Uplink Shared Channel) mainly transmits uplink data and uplink control data, and may also include downlink reception quality and control data such as ACK/NACK and the like. The information on allocation of radio resources on the uplink data channel is given by the downlink control channel, similarly to the downlink.

A random access channel (PRACH; Physical Radom Access Channel) is a channel used for notifying preamble sequences and has guard time. The random access channel is used as an accessing means of a mobile station device to a base station device. The mobile station device uses the random access channel to make a scheduling request of transmitted data when the uplink control channel is not set up and to request for transmission timing adjustment information required to adjust the uplink transmission timing to the reception timing window of the base station device. The mobile station device having received the transmission timing adjustment information sets up a valid period for the transmission timing adjustment information and manages its status as in transmission timing adjustment mode during the valid period and as in transmission timing non-adjustment mode during other than the valid period. It is also possible for the base station device to allot a dedicated preamble sequence (Dedicated preamble) to each mobile station device to thereby make the mobile station initiate random access.

A multicast channel (PMCH; Physical Multicast Channel) is a channel used for transmission of multicast signals, and is used to transmit a multicast control channel (MCCH; Multicast Control Channel) as the control information of MBMS and a multicast traffic channel (MTCH; Multicast Traffic Channel) as traffic data. Physical channels other than the above are not directly related to each of the embodiments of the present invention so that detailed description is omitted.

### The First Embodiment

The first embodiment of the present invention will be described hereinbelow.

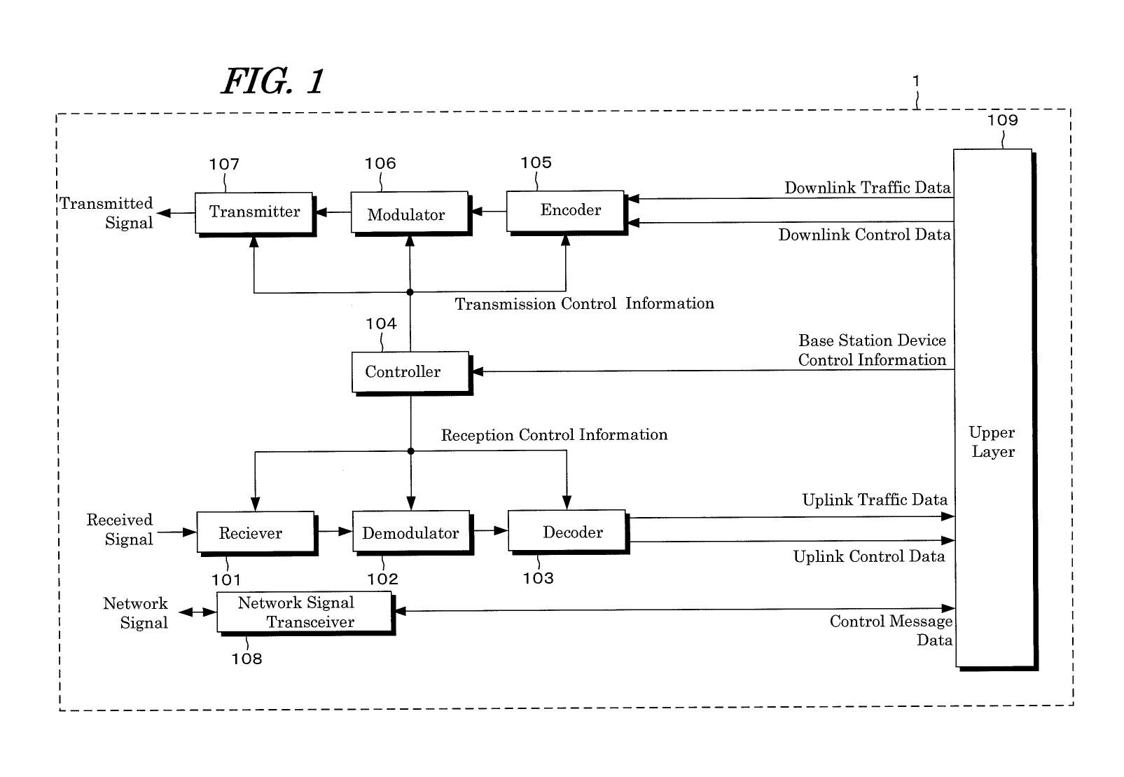

FIG. 1 is a block diagram showing one example of a base station device 1 according to the embodiment of the present invention. The base station device 1 includes a receiver 101, a demodulator 102, a decoder 103, a controller 104, an encoder 105, a modulator 106, a transmitter 107, a network signal transceiver 108 and an upper layer 109.

Upper layer 109 inputs downlink traffic data and downlink control data to encoder 105. Encoder 105 encodes each of the input data and transfers the data to modulator 106. Modulator 106 modulates the encoded signals. Also, in modulator 106, the modulated signals are multiplexed with a downlink reference signal and then mapped to the frequency band. Transmitter 107 converts the frequency band signal output from modulator 106 into a signal in the time domain. The converted signal is superimposed on the carrier wave of a predetermined frequency and power amplified and transmitted. The downlink data channel in which downlink control data is allotted typically forms layer 3 messages (RRC (Radio Resource Control) messages).

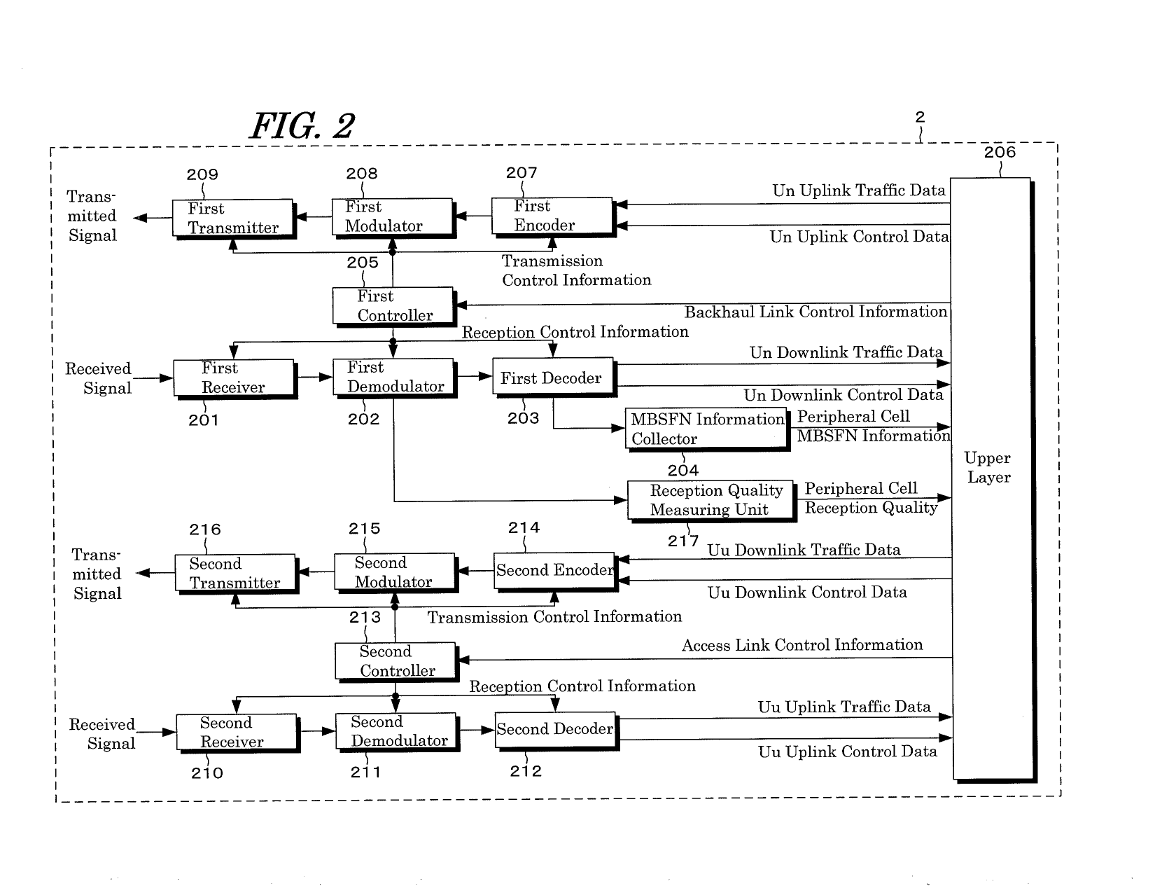

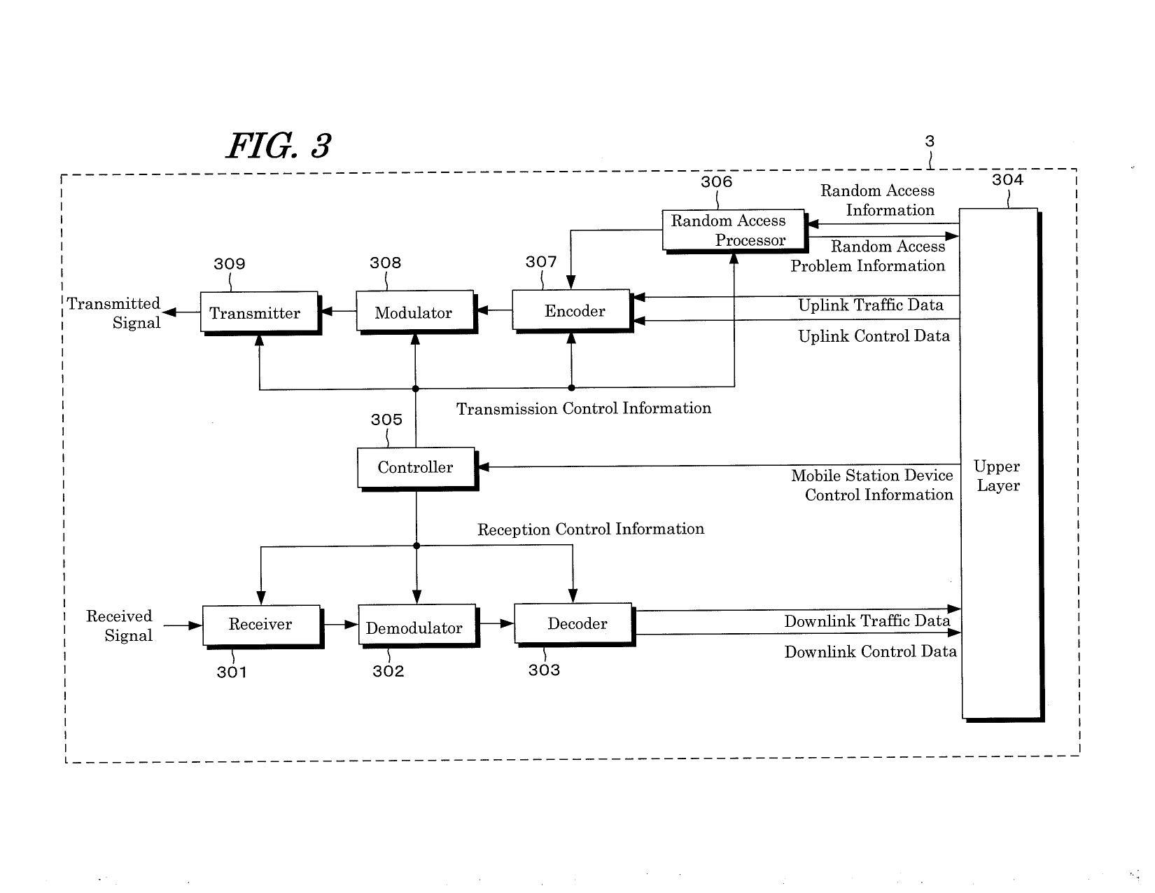

Receiver 101 converts the received signals from a relay station device 2 (see FIG. 2) and a mobile station device 3 (see FIG. 3) into digital signals in the based band. The digital signals are input to demodulator 102 and demodulated. The signals demodulated at demodulator 102 are supplied to decoder 103 and decoded therein. Decoder 103 appropriately separates the received signals into uplink traffic data and uplink control data and inputs the signals separately to upper layer 109.

The base station device control information required for control of each of these blocks is input from upper layer 109 to controller 104. Controller 104 appropriately supplies the base station device control information on transmission as transmission control information to each of blocks, or encoder 105, modulator 106 and transmitter 107 and supplies the base station device control information on reception as reception control information to each of blocks, or receiver 101, demodulator 102 and decoder 103.

On the other hand, network signal transceiver 108 handles transmission or reception of control messages between multiple base station devices 1 (or control station apparatus (MME), gateway apparatus (Gateway), MCE) and base station device 1. Control messages are transmitted and received by way of network lines. Control messages are exchanged on logical interfaces called S1 interface, X2 interface, M1 interface and M2 interface.

The RRC unit of base station device 1 exists as part of upper layer 109. In FIG. 1, other components of base station device 1 are not related to the present embodiment, are hence omitted.

FIG. 2 is a block diagram showing one example of relay station device 2 according to the embodiment of the present invention. This relay station device 2 includes a first receiver 201, a first demodulator 202, a first decoder 203, an MBSFN information collector 204, a reception quality measuring unit 217, a first controller 205, a first encoder 207, a first modulator 208, a first transmitter 209, an upper layer 206, a second receiver 210, a second demodulator 211, a second decoder 212, a second controller 213, a second encoder 214, a second modulator 215 and a second transmitter 216.

Relay station device 2 performs backhaul link communication with base station device 1 and performs access link communication with mobile station devices.

Upper layer 206 inputs Un uplink traffic data and Un uplink control data to first encoder 207, as backhaul link communication. First encoder 207 encodes each of the input data and supplies the data to first modulator 208. First modulator 208 modulates the encoded signals. In first modulator 208, the modulated signal is multiplexed with an uplink reference signal and mapped to the frequency band. First transmitter 209 converts the frequency band signal output from first modulator 208 into a signal in the time domain. The converted signal is superimposed on the carrier wave of a predetermined frequency and power amplified and transmitted.

First receiver 201 converts the received signal from base station device 1 into a digital signal in the based band. The digital signal is input to first demodulator 202 and demodulated therein. The signal demodulated at first demodulator 202 is then supplied to first decoder 203 and decoded therein. First decoder 203 appropriately separates the received signal into Un downlink traffic data and Un downlink control data and inputs the data separately to upper layer 206. The information on MBSFN (the identifier of MBSFN area, MBSFN subframe position used in the MBSFN area, the identifier of MBMS service, reception power, etc.), decoded at first decoder 203 is input to MBSFN information collector 204. MBSFN information collector 204 notifies upper layer 206 of information relating to MBSFN that has been collected from a single or multiple base station devices 1 and held therein. Reception quality measuring unit 217 measures reception quality, calculated based on the reception power of the down reference signal, the synchronization signal and the like, detected by first demodulator 202, and stores the reception quality paired with its physical cell ID (storing frequency information on the cell, if required) and notifies the reception quality to upper layer 206.

The information on the backhaul link, necessary for controlling each block, the backhaul control information, is input from upper layer 206 to first controller 205. First controller 205 appropriately inputs the control information relating to transmission to each of blocks, or first encoder 207, first modulator 208 and first transmitter 209 as transmission control information and inputs the control information relating to reception to each of blocks, first receiver 201, first demodulator 202 and first decoder 203, as reception control information.

Upper layer 206 inputs Uu downlink traffic data and Uu downlink control data to second encoder 214, as access link communication. Second encoder 214 encodes each of the input data and supplies the data to second modulator 215. Second modulator 215 modulates the encoded signal. In second modulator 215, the modulated signal is multiplexed with a downlink reference signal and mapped to the frequency band. Second transmitter 216 converts the frequency band signal output from second modulator 215 into a signal in the time domain. The converted signal is superimposed on the carrier wave of a predetermined frequency and power amplified and transmitted.

Second receiver 210 converts the received signal from mobile station device 3 into a digital signal in the based band. The digital signal is input to second demodulator 211 and demodulated therein. The signal demodulated at second demodulator 211 is then supplied to second decoder 212 and decoded therein. Second decoder 212 appropriately separates the received signal into Uu uplink traffic data and Uu uplink control data and inputs the data separately to upper layer 206.

The information on the access link, necessary for controlling each block, the access link control information, is input from upper layer 206 to second controller 213. Second controller 213 appropriately inputs the control information relating to transmission to each of blocks, or second encoder 214, second modulator 215 and second transmitter 216 as transmission control information and inputs the control information relating to reception to each of blocks, second receiver 210, second demodulator 211 and second decoder 212, as reception control information. In FIG. 2, other components of relay station device 2 are not related to the present embodiment, are hence omitted. Further, in FIG. 2, the processing units used for backhaul link transmission and reception and the processing units for access link may be used partly or as whole in common. In this case, the backhaul link process and the access link process are implemented time-divisionally.

FIG. 3 is a block diagram showing one example of a mobile station device 3 according to the embodiment of the present invention. This mobile station device 3 includes a receiver 301, a demodulator 302, a decoder 303, a controller 305, a random access processor 306, an encoder 307, a modulator 308, a transmitter 309 and an upper layer 304. Prior to reception, mobile station device control information is input from upper layer 304 to controller 305, and mobile station device control information on reception is appropriately input to receiver 301, demodulator 302 and decoder 303, as reception control information. The reception control information includes, as reception schedule information, demodulation information, decoding information, information on reception frequency band, reception timing relating to individual channels, multiplexing scheme, radio resource allocation information and other information.

The received signal is received at receiver 301 through one or more antennas (not shown). Receiver 301 receives the signal at the frequency band notified by the reception control information. Receiver 301 includes a baseband processor to the received signal. The received signal is input to demodulator 302. Demodulator 302 demodulates the received signal and supplies the received signal to decoder 303. Decoder 303 correctly decodes the received signal based on the reception control information. Decoder 303 appropriately separates the received signal into downlink traffic data and downlink control data, and separately input the data to upper layer 304.

Prior to transmission, mobile station device control information is input from upper layer 304 to controller 305, and mobile station device control information on transmission is appropriately input to random access processor 306, encoder 307, modulator 308 and transmitter 309, as transmission control information. The transmission control information includes, as uplink scheduling information on transmitted signal, encoding information, modulation information, timing relating to individual channels, multiplexing scheme, radio resource allocation information and other information. Input from upper layer 304 to random access processor 306 are radio resource information required for random access and random access information required for transmission of random access channel such as the maximum number of times of transmission and the like. When random access processor 306 detects a random access problem by counting the number of times of transmission of random access channel, the processor notifies random access problem information indicating the occurrence of a random access problem to upper layer 304.

In conformity with the uplink channels, uplink traffic data and uplink control data from upper layer 304 and random access data from random access processor 306 are appropriately input to encoder 307. Encoder 307, in accordance with the transmission control information, appropriately encodes each of the data and outputs the encoded data to modulator 308. Modulator 808 modulates the input from encoder 307.

Transmitter 309 maps the output from modulator 308 to the frequency band and converts the signal in the frequency band into a signal in the time domain, superimposes the signal on the carrier wave of a predetermined frequency, power amplifies the signal, and transmits the amplified signal. The uplink data channel in which uplink control data is allotted typically forms layer 3 messages (Radio Resource Control messages; RCC message). The RRC unit of mobile station device 3 exists as part of upper layer 304. Random access processor 306 exists as part of MAC (Medium Access Control) that manages the data link layer of mobile station device 3. In FIG. 3, other components of mobile station device 3 are not related to the present embodiment, are hence omitted.

First, description will be made on setup of MBSFN subframes in relay station device 2 when the prior art is used. MBSFN information collector 204 of relay station device 2 acquires an MBSFN subframe number from base station device 1 to be the DeNB. Upper layer 206 configures the acquired MBSFN subframe of DeNB in the MBSFN subframe of the own station, in addition to the MBSFN subframe for backhaul link communication, and informs mobile station device 3 by use of broadcast information included in Uu downlink traffic data. Further, relay station device 2 is adapted not to transmit PMCH or DSCH in the MBSFN subframe of the DeNB. This makes it possible to avoid interference from transmission of PDSCH and PMCH from relay station device 2, in the subframe which DeNB has set up in the MBSFN subframe.

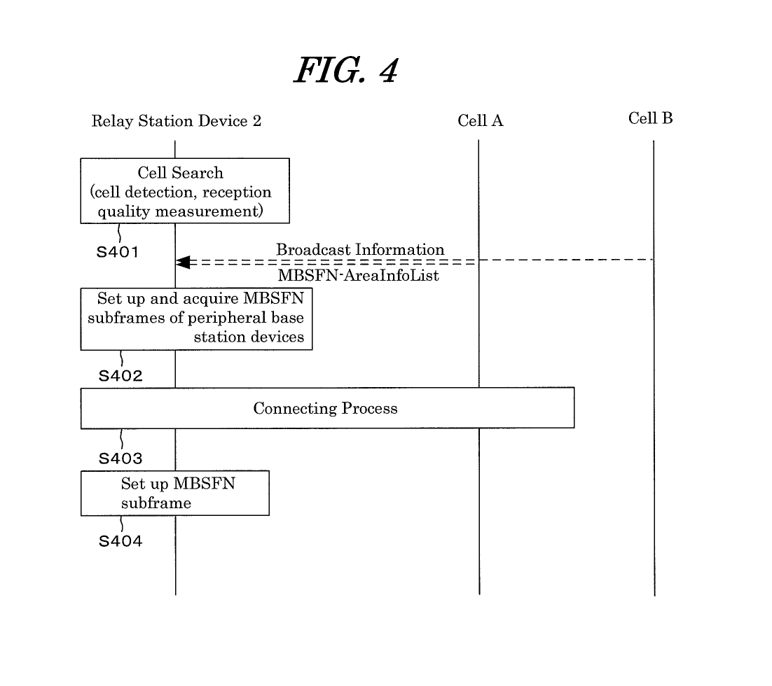

Next, the procedure of configuring MBSFN subframes in the present embodiment will be described using a sequence chart in FIG. 4.

To begin with, relay station device 2 of the present embodiment makes a cell search to detect cells therearound and measures the reception quality of the detected cells (Step S401). Next, the relay station acquires the broadcast information on the detected cells (cell A and cell B in this case) and obtains the MBSFN subframe configuration and MBSFN area's identifier information (Step S402). Further, the relay station selects a cell to be connected based on the broadcast information and reception quality obtained in the above process and performs a connecting process (Step S403).

Next, when having detected only a single cell in the same frequency band, relay station device 2 sets up the subframe allotted with the MBSFN area's identifier in MBSFN subframes and suspends this subframe from transmitting PMCH and PDSCH. On the other hand, when having detected multiple cells in the same frequency band by the cell search, the relay station sets up, among the acquired MBSFN subframes of multiple cells, the subframe allotted with same MBSFN area's identifier in MBSFN subframes, and suspends this subframe from transmitting PMCH and PDSCH. The subframe allotted with different MBSFN area's identifiers among the multiple cells will not be set up in MBSFN subframes (Step S404).

By the above procedure, it is possible for relay station device 2 to autonomously determine where the relay station itself is located in the MBSFN area.

According to the present embodiment, relay station device 2 avoids interference by setting up MBSFN subframes only when relay station device 2 is located near the center of the MBSFN area. When the relay station is located near the periphery of the MBSFN area, it is possible to increase communication capacity of the communication system without setting up an MBSFN subframe. Further, when relay station device 2 is adapted to periodically carry out the procedure of the present embodiment, it is possible to set up MBSFN subframes appropriately even when the MBSFN area is changed. When the MBSFN area is changed, it is possible to perform the process in response to a cutoff indication from cell A to which relay station device 2 is connected. When the DeNB that controls cell A notifies relay station device 2 of broadcast information of cell A by use of R-PDSCH, and if the information on the subframe to be used in the MBSFN area, included in the aforementioned information is changed, the relay station device 2 can reconfigure MBSFN subframes. Further, when MBSFN information is acquired by detecting cells by the aforementioned cell search, a cell whose reception power is lower than a predetermined threshold may be removed from the cells to be handled.

### The Second Embodiment

Next, the second embodiment of the present invention will be described. In the first embodiment relay station On the other hand, in the present embodiment, the base station device controls the configuration of MBSFN subframes, in response to the report from relay station device 2. The configuration of the communication system (mobile station device 3, base station device 1 and relay station device 2) used in the description of the present embodiment is the same as that of the first embodiment, hence description is omitted.

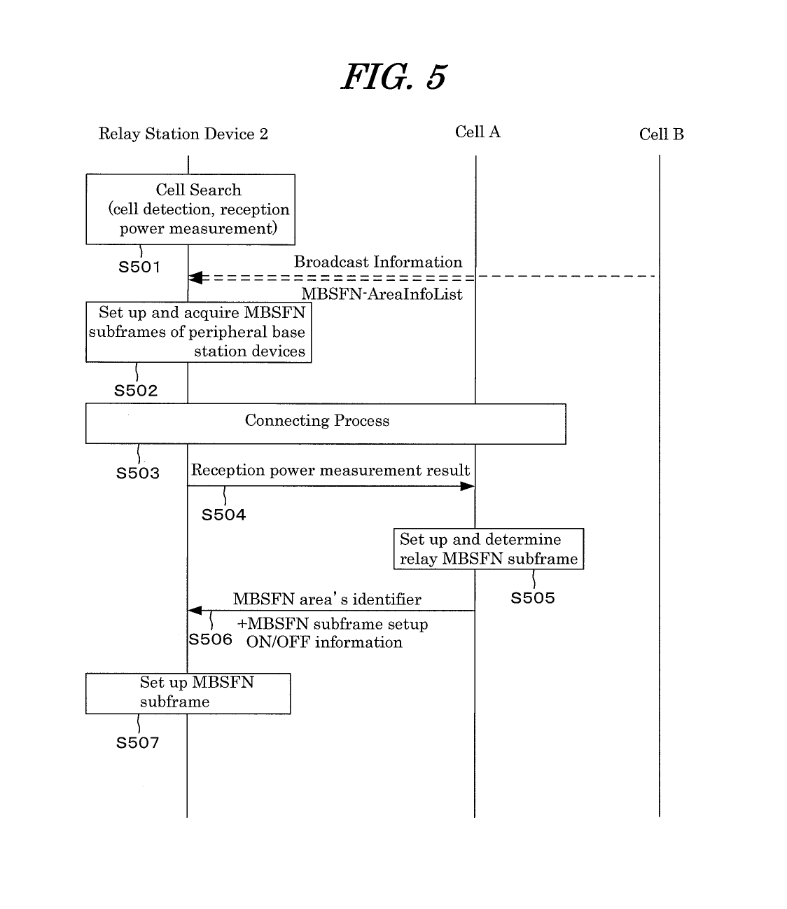

The procedure of configuring MBSFN subframes in the present embodiment will be described using a sequence chart in FIG. 5.

To being with, relay station device 2 of the present embodiment makes a cell search to detect cells therearound and measures the reception quality (reception power) of the detected cells (Step S501). Next, the relay station acquires the broadcast information on the detected cells (cell A and cell B in this case) and obtains the MBSFN subframe configuration and MBSFN area's identifier information (Step S502). Here, if the subframe to be set up in the MBSFN subframes is directly notified from base station device 1 at the aftermentioned Step S506, Step S502 is unnecessary. Next, relay station device 2 selects a cell to be connected based on the broadcast information and reception quality obtained in the above process and performs a connecting process (Step S503).

Next, relay station device 2 notifies the physical cell IDs and the measurements of reception power of the cells detected by the cell search to base station device 1 (DeNB) that controls the cell A to which the relay station connects (Step S504).

Base station device 1 that controls cell A, based on the physical cell IDs and the measurements of reception power, reported from relay station device 2, sets up the subframe allotted with the MBSFN area's identifier in the MBSFN subframe when relay station device 2 has detected its own cell (currently connected) only in the same frequency band, and when multiple cells have been detected in the same frequency band, the base station device sets up, among MBMS services offered by the acquired multiple cells, the subframe to which the MBMS service offered by the same MBSFN area's identifier as that of the own cell is allotted, in the MBSFN subframes of relay station device 2 (Step S505).

Next, base station device 1 notifies the MBSFN area's identifier paired with ON/OFF information for MBSFN subframe setting to relay station device 2 (Step S506).

Relay station device 2, based on the MBSFN area's identifier held by itself and the information on the subframe that is used by the service of this identifier, selects a subframe to be the MBSFN subframe from the MBSFN area's identifier and ON/OFF information for MBSFN subframe setting, notified from base station device 1, and sets the selected subframe in the MBSFN subframes (Step S507).

By the above process, it is possible to minimize the setting of MBSFN subframes of relay station device 2 even in an area where multiple MBSFN areas overlap. That is, when relay station device 2 is located near the center of MBSFN area A and at the periphery of another MBSFN area B, only the subframe used in MBSFN area A is set up in the MBSFN subframes in relay station device 2 so that this subframe will not be used for transmission of PMCH and PDSCH, whereby it is possible to minimize decrease of the communication capacity of the communication system and avoid interference.

At the above Step S506, the MBSFN area's identifier and ON/OFF information for MBSFN subframe setting are notified to relay station device 2 so that relay station device 2 sets up the MBSFN subframe. However, base station device 1 may set up the MBSFN subframe by itself and notify the setting of the MBSFN subframe to relay station device 2. In this case, the process at Step S502 is unnecessary as stated above. When the subframe to be used by the MBSFN area's identifier is changed in cell A of base station device 1, it is desirable that the change is notified by relay station device 2. Relay station device 2 notified of the change updates information on the MBSFN area's identifier held thereby and the information on the subframe used by the service of this identifier to reconfigure the MBSFN subframe.

In the present embodiment, relay station device 2 notifies the measurements of reception power on peripheral cells to DeNB at Step S504. However, the relay station may notify the measurements to the OAM (operations, administration, maintenance) that maintains and manages relay station device 2 by use of a message (NAS message) of a higher layer, so that the OAM directly sets up the MBSFN subframe, or by way of the OAM of base station device 1 the MBSFN subframe may be set up by base station device 1.

As the embodiments of the present invention have been described heretofore, as for the relay station device and base station device in the present invention, the program to realize the function of each component of the base station device or part of these functions may recorded in a computer readable recording medium so as to cause a computer system to read the program recorded on this recording medium, whereby the computer system executes the program to implement the control shown in each embodiment. The “computer system” herein is assumed to include an OS and hardware such as peripherals and the like.

Further, the “computer readable recording medium” may be a removable medium such as flexible disk, magneto-optical disk, ROM, CD-ROM and the like, or a storage device such as a hard disk or the like that is built in the computer system. The “computer readable recording medium” may further include those that dynamically hold the program in a short period of time such as a communication line for a case where the program is transmitted through a network such as the internet or a communication line such as the telephone line and also those that hold the program in a fixed period of time such as the volatile memory inside a computer system forming a server or a client for the case. Further, the above program may be one that realizes part of the above-described functions, or may be one that can realize the above-described functions in combination with programs that have been recorded beforehand in a computer system.

Further, individual functional blocks used in each of the above embodiments may be typically realized by an integrated circuit or LSI. Each functional block may be given in the form of separate chips, or the whole or part of the blocks may be integrated into a chip. The circuit integration may be realized in the form of a dedicated circuit or versatile processor, not limited to LSI. Further, if a technology of circuit integration replacing LSI technologies appears with the progress of semiconductor technologies, the integrated circuit based on that technology can also be used.

In each of the above embodiments, control is performed based on reception power. However, the signal to interference plus noise ratio, the path-loss value, i.e., the difference between the transmission power from the base station device and the reception power at the relay station device, or the like can also be used. Further, the physical cell ID of which the relay station device notifies the base station device or OAM, may use cell global ID (Cell Global Identity; CGI) included in SIB1.

Though the embodiments of this invention have been described in detail with reference to specific examples, it is obvious that the sprit and scope of claims of the present invention are not limited to these specific examples. That is, the description of the specification is intended to give exemplary illustration and should limit the present invention in any way.

### DESCRIPTION OF REFERENCE NUMERALS

1 . . . base station device
2 . . . relay station device
3 . . . mobile station device
101, 201, 210, 310 . . . receiver
102, 202, 211, 302 . . . demodulator
103, 203, 212, 303 . . . decoder
104, 205, 213, 305 . . . controller
105, 207, 214, 307 . . . encoder
106, 208, 215, 308 . . . modulator
107, 209, 216, 309 . . . transmitter
108 . . . network signal transceiver
109, 206, 304 . . . upper layer
204 . . . MBSFN information collector
217 . . . reception quality measuring unit
306 . . . random access processor

1. A relay station device comprising:
an MBSFN information collector that acquires and holds the identifiers of MBSFN areas of peripheral cells thereof and the used subframes, wherein
when there is only one peripheral cell, the relay station device, among the MBSFN subframes of the peripheral cell, the subframe to which the identifier of an MBSFN area is allotted is set to be included in the MBSFN subframes thereof.

2. A relay station device comprising:
an MBSFN information collector that acquires and holds the identifiers of MBSFN areas of peripheral cells thereof and the used subframes, wherein
when there are a plurality of peripheral cells, the relay station device, among the MBSFN subframes of the peripheral cells, the same subframes to which the identifier of the same MBSFN area is allotted is set to be included in the MBSFN subframes thereof.

3. A base station device that communicates with a relay station device, the base station device characterized in that,
the base station device notifies the relay station device of the identifier of an MBSFN area and whether the subframe used by the service of the identifier of the MBSFN area should be included in the MBSFN subframes of the relay station device.

4. A relay station device that communicates with the base station device according to claim 3,
wherein the relay station device holds the identifier of the MBSFN area of the base station device and information on the subframe used by the service of the identifier of the MBSFN area, and
the relay station device controls whether the subframe used by the service of the identifier of the MBSFN area, notified from the base station device, should be included in the MBSFN subframes thereof, based on a notice as to whether the subframe used by the service of the identifier of the MBSFN area is set up in the MBSFN subframes.

5. A communication system comprising:
a base station device; and
a relay station device,
wherein the relay station device holds information on reception power from peripheral cells thereof, the identifier of the MBSFN area of the peripheral cell to which the relay station connects and the subframe used by the service of the identifier of the MBSFN area, and the relay station device notifies the reception power of the peripheral cells to the base station device that controls the peripheral cell to which the relay station connects, and
wherein the base station device notifies the relay station device of the identifier of an MBSFN area and whether the subframe used by the service of the identifier of the MBSFN area should be set up in the MBSFN subframes, and,
wherein the relay station device, based on the identifier of the MBSFN area held thereby and the information on the subframe used by the service of the identifier of the MBSFN area, controls whether the subframe used by the service of the identifier of the MBSFN area, notified from the base station device, should be included in the MBSFN subframes thereof, based on a notice as to whether the subframe used by the service of the identifier of the MBSFN area are set up in the MBSFN subframes.

6. A communication method, wherein a base station device and a relay station device are provided, comprising:
a step in which the relay station device holds information on reception power from peripheral cells thereof, the identifier of the MBSFN area of the peripheral cell to which the relay station connects and the subframe used by the service of the identifier of the MBSFN area,
a step in which the relay station device notifies the reception power of the peripheral cells to the base station device that controls the peripheral cell to which the relay station connects,
a step in which the base station device notifies the relay station device of the identifier of an MBSFN area and whether the subframe used by the service of the identifier of the MBSFN area should be set up in the MBSFN subframes, and,
a step in which the relay station device, based on the identifier of the MBSFN area held thereby and the information on the subframe used by the service of the identifier of the MBSFN area, controls whether the subframe used by the service of the identifier of the MBSFN area, notified from the base station device, should be included in the MBSFN subframe thereof, based on a notice as to whether the subframes used by the service of the identifier of the MBSFN area is set up in the MBSFN subframes.
